(19) United States
(12) Patent Application Publication
(10) Pub. No.: US 2023/0058193 A1
(43) Pub. Date: Feb. 23, 2023

(54) COMPUTER SYSTEM AND STORAGE MEDIUM

(71) Applicant: RAKUTEN MOBILE, INC., Tokyo (JP)

(72) Inventor: Ryota MIBU, Tokyo (JP)

(21) Appl. No.: 17/793,921

(22) PCT Filed: Aug. 27, 2021
(86) PCT No.: PCT/JP2021/031592

§ 371 Date: Jul. 19, 2022

(30) Foreign Application Priority Data
Sep. 3, 2020 (JP) 2020-148060

(51) Int. Cl. G06F 9/455

(52) U.S. Cl. CPC G06F 9/45558; G06F 2009/4557; G06F 2009/45595

(57) ABSTRACT

A computer system includes a cluster management device and a server. A VM manager of the cluster management device manages execution of a workload (for example, a virtual machine (VM) on the server. A server manager of the cluster management device changes a power mode of a CPU of the server in accordance with a change in mode of the workload (for example, the VM) running on the server.

### RELATED APPLICATIONS

The present application is a National Phase of International Application No. PCT/JP2021/031592, filed Aug. 27, 2021, and claims priority based on Japanese Patent Application No. 2020-148060, filed Sep. 3, 2020.

### TECHNICAL FIELD

The present disclosure relates to a computer system and a computer program.

### BACKGROUND ART

There is known a virtualization technology with which a large number of general-purpose servers are installed in advance in a data center or the like, and when necessary, virtual machine software is deployed to each general-purpose server to cause the general-purpose server to perform a specific function.

### Citation List

### Patent Literature

[Patent Literature 1] JP 2020-027530 A

### SUMMARY OF INVENTION

### Technical Problem

A general-purpose server group installed in advance in a data center or the like tends to be large in power consumption because power equivalent to power necessary for running the virtual machine software is supplied even in a state of waiting for the introduction of the virtual machine software.

The present disclosure has been made in view of such a problem, and it is therefore an object of the present disclosure to provide a technology of reducing power consumption of a computer on which a workload runs in a virtualized environment.

### Solution to Problem

In order to solve the above-described problem, a computer system according to one aspect of the present invention includes a manager structured to manage execution of a workload on a server, and a controller structured to change a power mode of a CPU of the server in accordance with a change in mode of the workload running on the server.

Another aspect of the present disclosure is a computer program. The computer program causes a computer to execute managing execution of a workload on a server, and changing a power mode of a CPU of the server in accordance with a change in mode of the workload running on the server.

Note that any combination of the above-described components, or an entity that results from replacing expressions of the present disclosure among a device, a method, a recording medium storing a computer program in a readable manner, and the like is also valid as an aspect of the present disclosure.

### Advantageous Effects of Invention

According to the present disclosure, it is possible to reduce power consumption of a computer on which a workload run in a virtualized environment.

### BRIEF DESCRIPTION OF DRAWINGS

FIG. 1 is a diagram illustrating a configuration of a computer system of a first embodiment.

FIG. 2 is a flowchart illustrating how the computer system of the first embodiment operates.

FIG. 3 is a flowchart illustrating how the computer system of the first embodiment operates.

FIG. 4 is a diagram illustrating a configuration of a computer system of a second embodiment.

FIG. 5 is a diagram illustrating a configuration of a computer system of a third embodiment.

FIG. 6 is a flowchart illustrating how the computer system of the third embodiment operates.

FIGS. 7A and 7B are diagrams illustrating an example of operation states of a plurality of servers.

FIG. 8 is a flowchart illustrating how the computer system of the third embodiment operates.

### DESCRIPTION OF EMBODIMENTS

Infrastructure as a service (IaaS) for providing infrastructure such as equipment including a server and a network necessary for running an information system as a service on the Internet using a virtualization technology has become widespread. In IaaS, a large number of general-purpose servers (physical servers) are installed in advance in a data center or the like, and virtual machine software (hereinafter, also referred to as a “VM”) is run on a corresponding one of the general-purpose servers (physical servers) in response to a user’s request, thereby providing a virtual server that matches the user’s request.

The following embodiments propose a technology of changing a power mode of a central processing unit (CPU) of each physical server when deploying the VM to the physical server, specifically, changing a sleep setting of the CPU, in a computer system that provides IaaS. The computer system of the embodiments allows a reduction in power consumption of the computer on which the VM is run on demand in a virtualized environment.

In the following embodiments, virtualization software “OpenStack” is deployed to a physical server, and one or more VMs are run on the physical server. A modification may be employed where a container engine “Docker” is deployed to the physical server, and one or more containers (also referred to as “Pods”) are be run on the physical server. The VM and the container (Pod) are also collectively referred to as a “workload”.

### First Embodiment

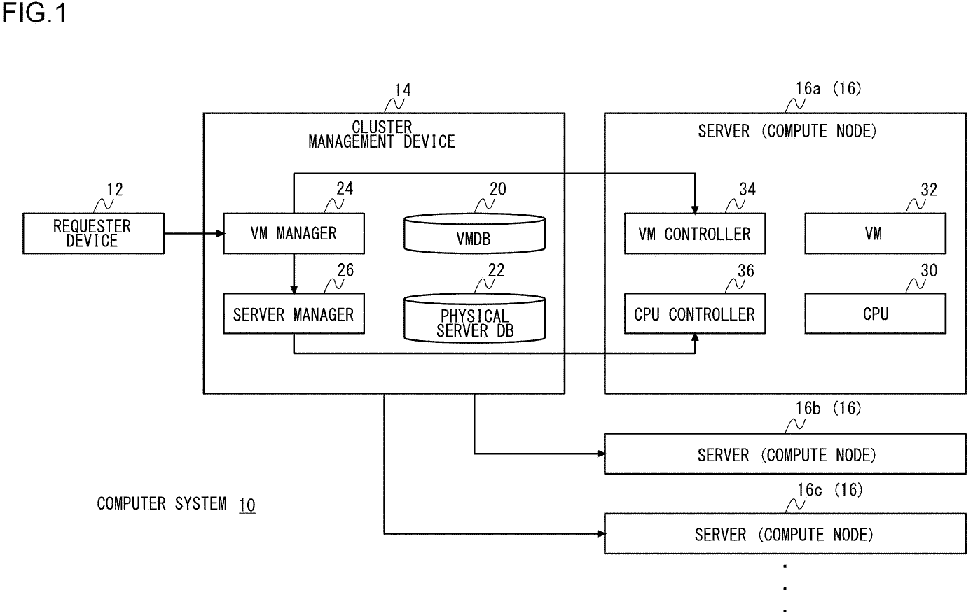

FIG. 1 illustrates a configuration of a computer system 10 according to a first embodiment. The computer system 10 is also referred to as a data processing system, and includes a requester device 12, a cluster management device 14, and a plurality of servers (a server 16a, a server 16b, a server 16c, ...). Hereinafter, the plurality of servers (the server 16a, the server 16b, the server 16c, ...) are also collectively referred to as a “server 16”. The cluster management device 14 and the server 16 may be installed in a data center and connected over a LAN of the data center. Further, several tens to several hundreds of servers 16 may be installed in one data center. Further, the requester device 12 and the cluster management device 14 may be connected over the Internet.

FIG. 1 is a block diagram illustrating functional blocks of the cluster management device 14 and the server 16. The plurality of functional blocks illustrated in the block diagrams of the present specification may be implemented, in terms of hardware, by a circuit block, a memory, and other LSI and implemented, in terms of software, by a program loaded on a memory and executed by a CPU. Therefore, it is to be understood by those skilled in the art that these functional blocks may be implemented in various forms such as hardware only, software only, or a combination of hardware and software, and how to implement the functional blocks is not limited to any one of the above.

The server 16 is an information processing device that is also referred to as a compute node. The server 16 is a physical server that provides various resources (a CPU, a memory, a storage, and the like) for running the VM. The server 16 includes a CPU 30, a VM 32, a VM controller 34, and a CPU controller 36.

The VM controller 34 and the CPU controller 36 may be implemented as a computer program, and the computer program may be stored in a storage (not illustrated) of the server 16. The CPU 30 may load the computer program into a main memory (not illustrated) and run the computer program to perform the functions of the VM controller 34 and the CPU controller 36.

The VM controller 34 controls the execution of the VM 32 on the server 16. Specifically, the VM controller 34 causes the CPU 30 to run the program of the VM 32 in accordance with an instruction from the cluster management device 14 so as to implement a virtual server. In the embodiment, the program of the VM 32 is provided from the cluster management device 14. The VM controller 34 may be implemented via the function of OpenStack.

The CPU controller 36 controls a power mode of the CPU 30 of the server 16. The CPU controller 36 of the embodiment includes a function of a known baseboard management controller (BMC), and receives a request to change the power mode of the CPU 30 from a remote site via an intelligent platform management interface (IPMI).

In the embodiment, the CPU controller 36 brings, in accordance with an instruction from the cluster management device 14, the CPU 30 into (1) a power mode in which the CPU does not enter a sleep state, in other words, a power mode in which the CPU is prohibited from entering the sleep state (hereinafter, referred to as “C6 disabled”). Further, the CPU controller 36 brings, in accordance with an instruction from the cluster management device 14, the CPU 30 into (2) a power mode in which the CPU is permitted to enter the sleep state, for example, a power mode in which the CPU enters the sleep state when a task such as the VM is not running (hereinafter, also referred to as “C6 enabled”).

“C6” denotes the deepest sleep state among C states indicating the power mode of the CPU 30 in which power consumption of the CPU 30 becomes the smallest. Further, returning from the “C6” to an in-use state “C0” takes longer than returning from other C states, but it is still less than 1 second. In the present embodiment, the CPU 30 of the server 16 on which no VM is running is in the C6 sleep state. Note that the sleep mode (C state) of the CPU 30 of the server 16 on which no VM is running is not limited to C6. A developer may weigh the power consumption and the time taken for a return to C0 to determine a suitable sleep mode.

In the embodiment, the virtual server implemented by the VM 32 runs an application relating to business of a telecommunications carrier. The application may be, for example, an application (vCU, vDU, etc.) of a radio access network (RAN) of a fifth generation mobile communication system (5G) or an application (AMF, SMF, etc.) of a 5G core network system. Since the business application of the telecommunications carrier is required to perform real-time processing (in other words, ultra-low latency processing), the VM 32 needs to be run on the server 16 in a power mode (C6 disabled) in which the CPU does not enter the sleep state.

The requester device 12 is an information processing device that requests creation or deletion of a VM (in other words, a virtual server). The requester device 12 may be a device (PC or the like) operated by a person, or may be a system/device that automatically performs data processing without the help of a person, such as an element management system (EMS). The requester device 12 transmits a VM creation request or a VM deletion request to the cluster management device 14. The VM creation request may contain information specifying a resource amount of each of the CPU, the memory, and the storage to be allocated to a new VM, the type of an OS, and the like. The VM deletion request may contain identification information on a VM to be deleted.

The cluster management device 14 is an information processing device that manages a plurality of servers 16 (also referred to as a “cluster”). Although one cluster management device 14 is illustrated in FIG. 1, the cluster management device 14 may be made up of a plurality of devices to have redundancy. The cluster management device 14 includes a VMDB 20, a physical server DB 22, a VM manager 24, and a server manager 26.

The VMDB 20 stores VM image data (program) used for running a corresponding VM on the server 16. Further, the VMDB 20 stores identification information on the server 16 and identification information on the VM running on the server 16 with both the pieces of identification information associated with each other. In other words, the VMDB 20 stores information on the VM running on each of the plurality of servers 16 (an ID of the VM or the like).

Further, the VMDB 20 stores data necessary for selecting a server 16 on which the VM is run from among the plurality of servers 16. For example, the VMDB 20 may store available hardware resources (CPU, memory, storage, and the like) of each server 16. The VMDB 20 may be implemented via the function of OpenStack.

The physical server DB 22 stores identification information on each of the plurality of servers 16 and data necessary for communications with each server 16. For example, the physical server DB 22 may store (1) a host name and (2) an IP address of each of the plurality of servers 16, and (3) information necessary for accessing the BMC (CPU controller 36) of each of the plurality of servers 16 via the IPMI.

Further, the physical server DB 22 stores the operation state of each of the plurality of servers 16, in other words, stores data showing which of the plurality of operation states each server 16 is in. The plurality of operation states include (1) an in-use state, (2) the standby state, and (3) a power-off state. (1) The in-use state is an operation state in which power is supplied (power-on state), and the CPU is in a power mode (C6 disabled) in which the CPU does not enter the sleep state. (2) The standby state is an operation state in which power is supplied (power-on state), and the CPU in a power mode (C6 enabled) in which the CPU is permitted to enter the sleep state. (3) The power-off state is a state in which power supply is interrupted, and can also be referred to as a power-interruption state.

The VM manager 24 and the server manager 26 may be implemented as a computer program, and the computer program may be stored in a storage (not illustrated) of the cluster management device 14. The CPU of the cluster management device 14 may load the computer program into a main memory (not illustrated) and run the computer program to perform the functions of the VM manager 24 and the server manager 26.

The VM manager 24 manages the execution of the VM on each of the plurality of servers 16. The VM manager 24 may be implemented via the function of OpenStack. Upon receipt of the VM creation request transmitted from the requester device 12, the VM manager 24 selects a server 16 (hereinafter, also referred to as a “target server”) on which the VM is run from among the plurality of servers 16 in accordance with the hardware resource amount shown by the VM creation request, and the VM running status and the available resource amount of each server 16 stored in the VMDB 20. The VM manager 24 transmits VM image data corresponding to the VM creation request to the VM controller 34 of the target server, and causes the VM to start to run on the target server.

The server manager 26 changes the power mode of the CPU of the server 16 in accordance with a change in the mode of the VM running on the server 16. In the first embodiment, the server manager 26 changes the power mode of the CPU of at least one server 16 of the plurality of servers 16 under management in accordance with a change in the mode of the VM running on the at least one server 16 of the plurality of servers 16.

Further, when the VM manager 24 determines to run the VM on a certain server 16, the server manager 26 brings the CPU of the certain server 16 into the power mode (C6 disabled) in which the CPU does not enter the sleep state. The server manager 26 may change the power mode of the CPU of each server 16 by accessing the BMC (CPU controller 36) of each server 16 via the IPMI.

A description will be given below of how the computer system 10 of the first embodiment operates. Here, the operation state of each of the plurality of servers 16 is set to either the in-use state or the standby state. Further, the operation state of the server 16 on which no VM is running set to the standby state.

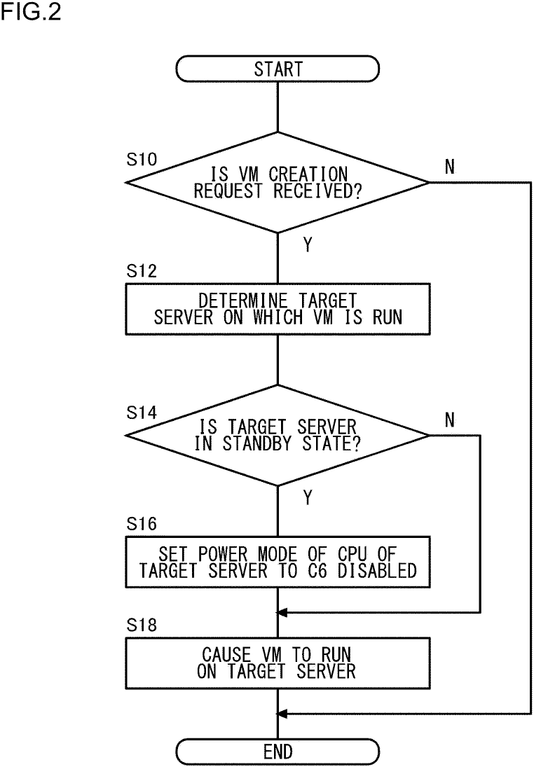

FIG. 2 is a flowchart illustrating how the computer system 10 of the first embodiment operates. FIG. 2 illustrates an operation when creating a new VM, in other words, when creating a new virtual server. The requester device 12 transmits the VM creation request to the cluster management device 14. Upon receipt of the VM creation request transmitted from the requester device 12 (Y in S10), the VM manager 24 of the cluster management device 14 selects a server 16 (referred to as a “target server”) on which a new VM corresponding to the VM creation request is run (S12). The VM manager 24 notifies the server manager 26 of identification information on the target server (for example, a host name or the like).

The server manager 26 consults the physical server DB 22 to check whether the target server notified from the VM manager 24 is in the standby state. When the target server is in the standby state (Y in S14), the server manager 26 cooperates with the CPU controller 36 of the target server to set the power mode of the CPU of the target server to C6 disabled (S16). In other words, the server manager 26 brings the target server from the standby state into the in-use state. When the target server is in the in-use state (N in S14), S16 is skipped. The server manager 26 notifies the VM manager 24 that the target server is in the in-use state.

The VM manager 24 cooperates with the VM controller 34 of the target server to cause the VM to start to run on the target server (S18). The VM manager 24 records, in the VMDB 20, the fact that the new VM is running on the target server. When no VM creation request is received (N in S10), S12 and the subsequent steps are skipped. The cluster management device 14 repeatedly performs a series of steps illustrated in FIG. 2.

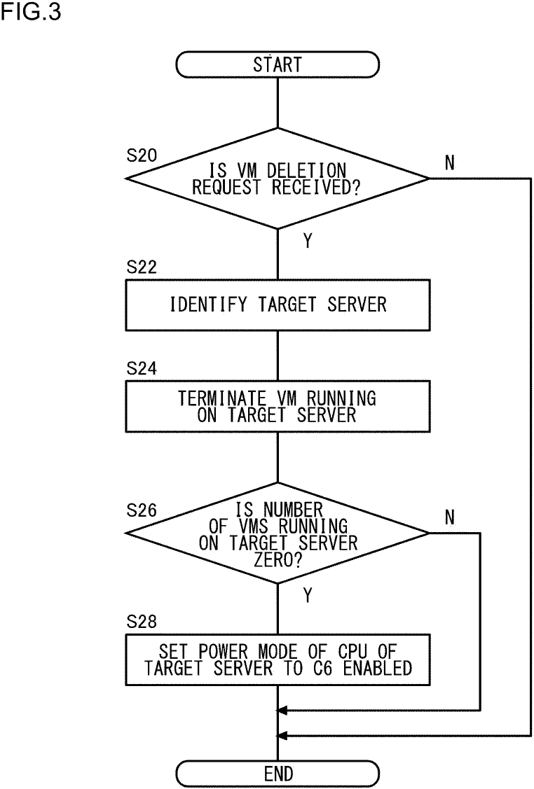

FIG. 3 is also a flowchart illustrating how the computer system 10 of the first embodiment operates. FIG. 3 illustrates an operation when deleting an existing VM, in other words, when deleting an existing virtual server. The requester device 12 transmits the VM deletion request to the cluster management device 14. Upon receipt of the VM deletion request transmitted from the requester device 12 (Y in S20), the VM manager 24 of the cluster management device 14 consults the VMDB 20 to identify a server 16 (referred to as a “target server”) on which the VM (referred to as a “target VM”) is running specified by the VM deletion request (S22). The VM manager 24 cooperates with the VM controller 34 of the target server to terminate the target VM running on the target server (S24).

The VM manager 24 records, in the VMDB 20, the fact that the target VM has been deleted from the target server, in other words, deletes mapping between the target server and the target VM in the VMDB 20. The VM manager 24 notifies the server manager 26 that the target VM has been deleted from the target server. The server manager 26 consults the VMDB 20 to count the number of VMs running on the target server. When the number of VMs running on the target server is zero (Y in S26), the server manager 26 sets the power mode of the CPU of the target server to C6 enabled (S28). In other words, the server manager 26 brings the target server from the in-use state into the standby state.

When one or more VMs are running on the target server (N in S26), S28 is skipped. When no VM deletion request is received (N in S20), S22 and the subsequent steps are skipped. The cluster management device 14 repeatedly performs a series of steps illustrated in FIG. 3.

The computer system 10 of the first embodiment changes the power mode of the CPU of each of the servers 16 constituting the cluster in accordance with the mode of the VM running on the server 16, in other words, a condition where how the virtual server is provided. This makes it possible to reduce power consumption of the server 16 on which the VM is run on demand in the virtualized environment. Further, the computer system 10 sets the server 16 on which the VM is run into the power mode (C6 disabled) in which the CPU does not enter the sleep state. This makes it possible to implement a virtual server suitable for application processing in real time (in other words, with ultra-low latency).

An experiment performed by the present inventor shows that the power consumption of a server 16 (having no VM deployed thereto) having the power mode of the CPU set to C6 disabled is 234 W, whereas the power consumption of a server 16 (having no VM deployed thereto) having the power mode of the CPU set to C6 enabled is 140 W. That is, it was confirmed that the power consumption can be reduced by 41% by setting the power mode of the CPU of the server 16 having no VM deployed thereto to C6 enabled. In the data center, several tens to several hundreds of servers 16 may be installed, and, for example, when 100 servers 16 are set into C6 enabled, power consumption can be reduced by 9400 W.

Although it takes several minutes to 10 minutes for the server 16 to change from the power-off state to the in-use state, a change from the standby state (C6 enabled) to the in-use state (C6 disabled) is less than 1 second as described above. According to the first embodiment, causing the server 16 on which no VM is running to wait in the standby state allows a reduction in the power consumption of the server 16 on which no VM is running while making the time taken for the VM to start to run shorter.

### Second Embodiment

The present embodiment will be described below focusing on differences from the first embodiment, and no description will be given of common points as necessary. In the description, among the components of the present embodiment, components that are the same as or correspond to the components of the first embodiment will be denoted by the same reference numerals as of the components of the first embodiment.

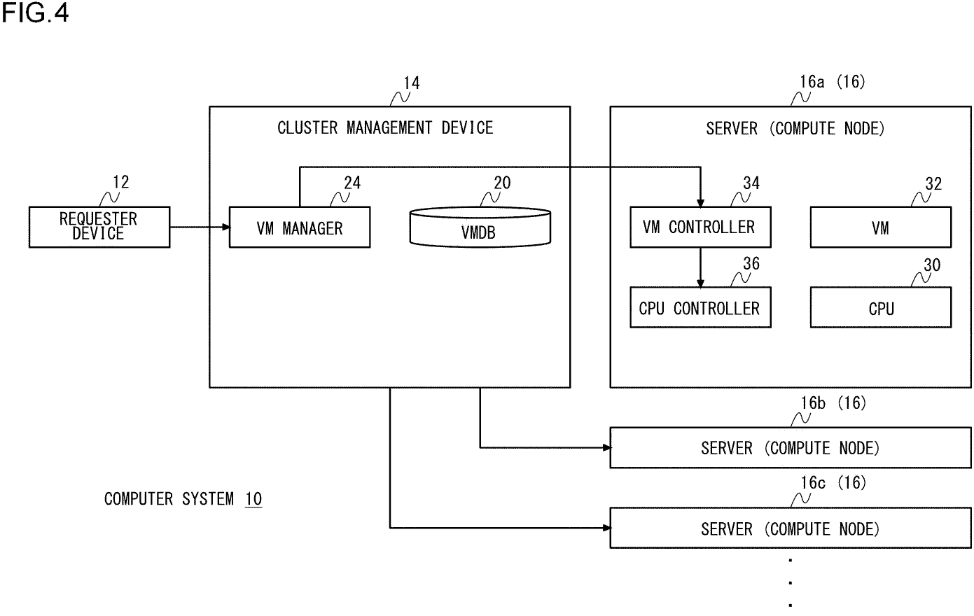

FIG. 4 illustrates a configuration of a computer system 10 according to a second embodiment. A VM controller 34 of a server 16 of the second embodiment has the function of the server manager 26 of the cluster management device 14 of the first embodiment in addition to the function of the VM controller 34 of the first embodiment.

For example, the VM controller 34 of the server 16 causes the CPU 30 to run the program of the VM 32 in accordance with an instruction from the cluster management device 14, and cooperates with the CPU controller 36 to change the power mode of the CPU 30 of the server 16 in accordance with a change in the mode of the VM running on the server 16. Further, the VM controller 34 brings, upon receipt of a VM execution instruction with the server 16 to which the VM controller 34 belongs in the standby state, the power mode of the CPU 30 of the server 16 from C6 enabled into C6 disabled in cooperation with the CPU controller 36.

The computer system 10 of the second embodiment produces the same effect as the computer system 10 of the first embodiment. Note that, in the second embodiment, the VM controller 34 of the server 16 has the function of the server manager 26 of the cluster management device 14 of the first embodiment, but, as a modification, the CPU controller 36 of the server 16 may have the function of the server manager 26 of the cluster management device 14 of the first embodiment.

### Third Embodiment

The present embodiment will be described below focusing on differences from the first embodiment, and no description will be given of common points as necessary. In the description, among the components of the present embodiment, components that are the same as or correspond to the components of the first embodiment will be denoted by the same reference numerals as of the components of the first embodiment.

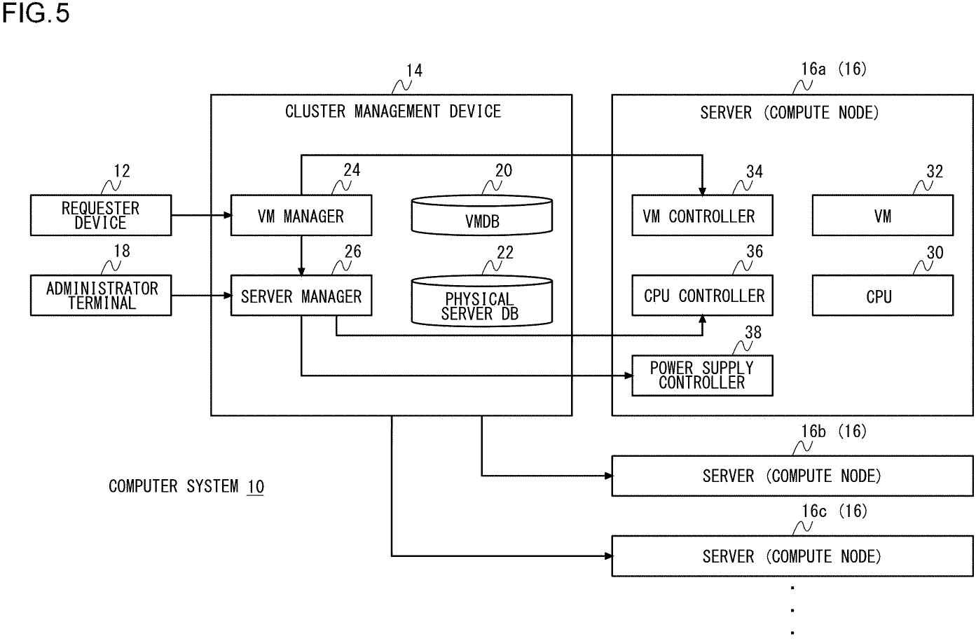

FIG. 5 illustrates a configuration of a computer system 10 according to a third embodiment. A server 16 of the third embodiment includes a power supply controller 38 in addition to the functional blocks of the server 16 of the first embodiment illustrated in FIG. 1. The power supply controller 38 controls whether to supply power to the server 16 (that is, turn on or off the power supply). In the third embodiment, the operation state of each of the plurality of servers 16 is controlled to any one of (1) the in-use state, (2) the standby state, or (3) the power-off state.

Note that the power supply controller 38 of the third embodiment includes the function of the BMC. It is assumed that the server manager 26 of the cluster management device 14 accesses the power supply controller 38 of the server 16 via the IPMI to remotely control whether to supply power to the server 16 (that is, turn on or off the power supply).

The computer system 10 of the third embodiment includes an administrator terminal 18 operated by an administrator of the computer system 10. The administrator terminal 18 transmits a value of a proportion of standby servers determined in advance by the administrator to the cluster management device 14. The proportion of standby servers is a proportion of servers 16 in the standby state to the plurality of servers 16 (the total number of servers 16 in the cluster). In the embodiment, the proportion of standby servers is 30%, but the proportion of standby servers may be a value different from 30%. The proportion of standby servers may be determined to an appropriate value on the basis of knowledge of the administrator or an experiment using the computer system 10.

The server manager 26 of the cluster management device 14 stores the proportion of standby servers transmitted from the administrator terminal 18. The server manager 26 changes the power mode of the CPU of at least one server of the plurality of servers 16 in accordance with a change in the mode of the VM running on the at least one server 16 of the plurality of servers 16 and the proportion of standby servers stored in advance.

Here, it is assumed that the plurality of servers 16 includes a first server that is in the standby state and a second server that is in the power-off state (power supply interruption state), and the VM manager 24 of the cluster management device 14 determines to run the VM on the first server. In this case, the server manager 26 of the cluster management device 14 brings the CPU of the first server into the power mode (C6 disabled) in which the CPU does not enter the sleep state, in other words, brings the first server into the in-use state. The VM manager 24 causes the VM to run on the first server. The server manager 26 brings the second server into the standby state in accordance with the proportion of standby servers.

Further, it is assumed that the VM manager 24 terminates the VM running on a certain server 16, and there is no VM running on the certain server 16 accordingly. In this case, the server manager 26 brings the certain server 16 into either the standby state or the power-off state in accordance with the proportion of standby servers. The server manager 26 controls the operation state of the server 16 on which no VM is running to either the standby state or the power-off state so as to maintain the proportion of standby servers determined by the administrator. Maintaining the proportion of standby servers may mean causing a difference between the actual proportion of servers 16 in the standby state to the total number of servers 16 and the proportion of standby servers to fall within a predetermined threshold (for example, within a range of ±5%).

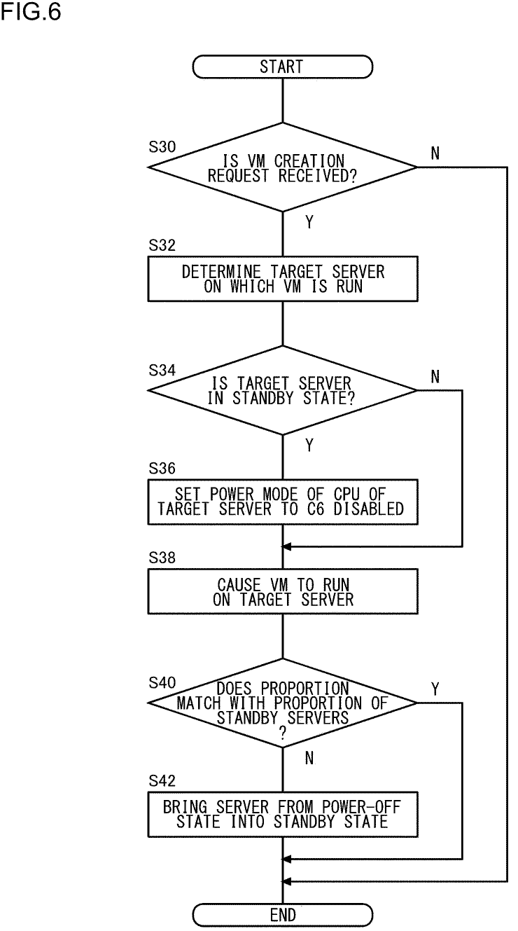

A description will be given below of how the computer system 10 of the third embodiment operates. FIG. 6 is a flowchart illustrating how the computer system 10 of the third embodiment operates. S30 to S38 in FIG. 6 are the same as S10 to S18 in FIG. 2 described in the first embodiment, and thus no description will be given below of S30 to S38. Note that, in S12, the VM manager 24 of the cluster management device 14 determines a target server on which a new VM is run from among the servers 16 in the in-use state or the standby state. Here, the proportion of standby servers is set to 30%.

After causing the new VM to run on the target server, the server manager 26 of the cluster management device 14 consults the physical server DB 22 to check whether the actual proportion of servers 16 in the standby state to the total number of servers 16 under management matches with the proportion of standby servers. When the actual proportion does not match with the proportion of standby servers (typically, the actual proportion falls below the proportion of standby servers by more than the threshold, for example, the actual proportion is less than 25%) (N in S40), the server manager 26 brings the server 16 from the power-off state into the standby state (S42).

When the actual proportion of servers 16 in the standby state to the total number of servers 16 under management matches with the proportion of standby servers (for example, when the actual proportion is 25% to 35%) (Y in S40), S42 is skipped.

In S42, specifically, the server manager 26 cooperates with the power supply controller 38 of a server 16 in the power-off state to power the server 16 on (brings the server 16 into a power supply state). Further, the server manager 26 cooperates with the CPU controller 36 of the server 16 to set the CPU of the server 16 into C6 enabled.

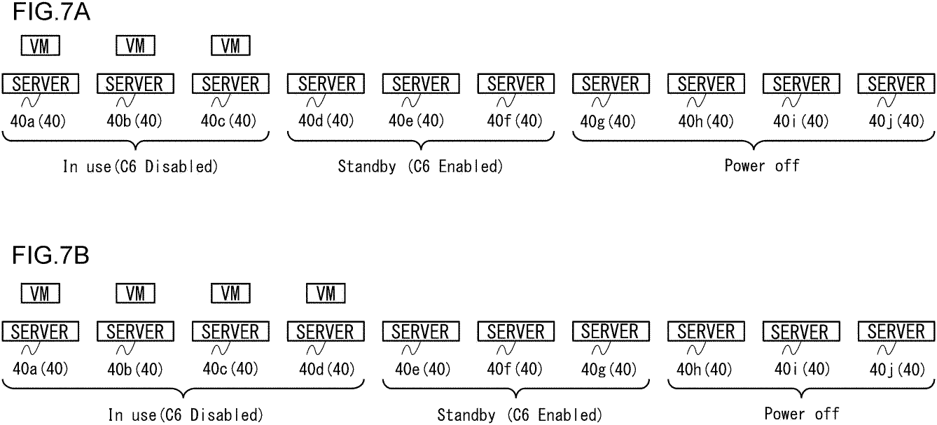

FIGS. 7A and 7B illustrate an example of operation states of a plurality of servers. In this example, 10 servers 40 (servers 40a to 40j) are installed as a cluster. The servers 40 correspond to the servers 16 illustrated in FIG. 5. When the VM manager 24 of the cluster management device 14 determines to run a new VM on the server 40d in the state of FIG. 7A, the server manager 26 of the cluster management device 14 brings the server 40d from the standby state into the in-use state. As a result, the number of servers 40 in the standby state among the 10 servers 40 becomes two (the server 40e and the server 40f), which does not match with the proportion of standby servers.

Therefore, as illustrated in FIG. 7B, the server manager 26 selects one server 40 (here, the server 40g) from among the servers 40 in the power-off state and brings the server 40g from the power-off state into the standby state. As a result, the number of servers 40 in the standby state among the 10 servers 40 becomes three (the server 40e, the server 40f, and the server 40g), which matches with the proportion of standby servers.

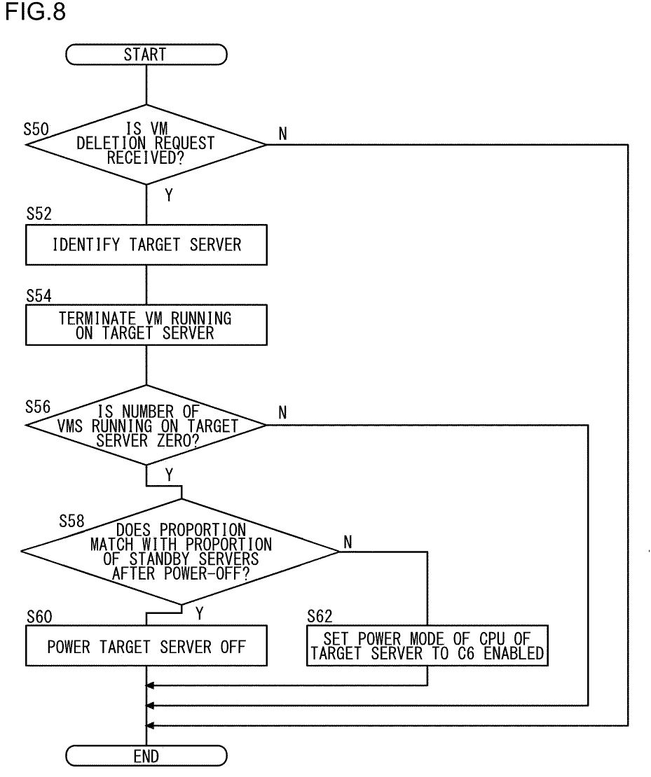

FIG. 8 is also a flowchart illustrating how the computer system 10 of the third embodiment operates. S50 to S54 in FIG. 8 are the same as S20 to S24 in FIG. 3 described in the first embodiment, and thus no description will be given below of S50 to S54.

When the number of VMs running on the target server from which the VM has been deleted becomes zero (Y in S56), the server manager 26 of the cluster management device 14 determines whether the proportion matches with the proportion of standby servers when the target server is powered off. When the proportion matches with the proportion of standby servers (Y in S58), the server manager 26 cooperates with the power supply controller 38 of the target server to power the target server off (brings the target server into the power supply interruption state) (S60).

When the proportion does not match with the proportion of standby servers when the target server is powered off (N in S58), the server manager 26 cooperates with the CPU controller 36 of the target server with the target server maintained in the power-on state to set the power mode of the CPU of the target server to C6 enabled (S62). That is, the target server is brought from the in-use state into the standby state. When one or more VMs are running on the target server (N in S56), S58 to S62 are skipped.

For example, it is assumed that the VM is deleted from the server 40d among the plurality of servers 40 in the operation states illustrated in FIG. 7B. At this time, when the server 40d is powered off, the number of servers 40 in the standby state among the 10 servers 40 becomes three (the server 40e, the server 40f, and the server 40g), so that the server manager 26 determines that the proportion matches with the proportion of standby servers. The server manager 26 powers the server 40d off to bring the server 40d directly from the in-use state into the power-off state.

In the computer system 10 of the third embodiment, it is possible to further reduce power consumption of the entire server group by permitting some of the servers (compute nodes) on which no VM is running to enter the power-off state. Further, maintaining the number of servers in the standby state to a certain extent on the basis of the proportion of standby servers allows, even when many new VMs are to be activated, such new VMs to be activated in a short time (for example, in the order of several seconds).

The present disclosure has been described above on the basis of the first to third embodiments. It is to be understood by those skilled in the art that these embodiments are illustrative and that various modifications are possible for a combination of components or processes, and that such modifications are also within the scope of the present disclosure.

A description will be given below of modifications of the first to third embodiments. The functions of the VM controller 34 and the CPU controller 36 of the server 16 may be implemented as functions of the VM (or the container). Here, a VM responsible for performing the functions of the VM controller 34 and the CPU controller 36 is referred to as an “underlying VM”, and a VM created in response to the VM creation request from the requester device 12 is referred to as a “service VM”. When counting the number of VMs running on the server 16, the server manager 26 of the cluster management device 14 may count the number of service VMs obtained by excluding the underlying VM from the VMs running on the server 16, in other words, may exclude the underlying VM from counting targets.

A modification of the third embodiment will be described below. The server manager 26 of the cluster management device 14 may transmit alert information to the administrator terminal 18 when the proportion of standby servers determined by the administrator cannot be maintained as a result of changing the operation mode (in other words, the power mode of the CPU) of at least one server 16 of the plurality of servers 16. For example, when the actual proportion of servers 16 in the standby state to the total number of servers 16 falls below the proportion of standby servers by more than the threshold, the server manager 26 may transmit alert information showing the fact to the administrator terminal 18. This makes it possible to aid in configuration management of devices in the data center, for example, makes it possible to aid in a determination as to whether to increase the number of servers 16 or the like.

Any combination of the above embodiments and modifications is also effective as an embodiment of the present disclosure. A new embodiment resulting from such a combination exhibits the effect of each of the embodiments and modifications constituting the combination.

Further, it is to be understood by those skilled in the art that a function to be fulfilled by each of the components described in the claims can be implemented by one of the components described in the embodiments and the modifications or via cooperation among the components. For example, the manager described in the claims may be implemented by any one of the VM manager 24 of the cluster management device 14 or the VM controller 34 of the server 16 described in each embodiment, or may be implemented via cooperation between the VM manager 24 and the VM controller 34. Further, the controller described in the claims may be implemented by any one of the server manager 26 of the cluster management device 14 or the CPU controller 36 of the server 16 described in each embodiment, or may be implemented via cooperation between the server manager 26 and the CPU controller 36. That is, the manager and the controller described in the claims may be each implemented by any computer included in the computer system 10, or may be implemented via cooperation among a plurality of computers.

### Industrial Applicability

The technology of the present disclosure is applicable to a computer system responsible for managing execution of a workload.

1. A computer system comprising:
one or more processors comprising hardware, wherein
the one or more processors are configured to implement: a manager structured to manage execution of a workload on a server; and
a controller structured to change a power mode of a CPU of the server in accordance with a change in mode of the workload running on the server.

2. The computer system according to claim 1, wherein
the workload is to be run on a server that is in a power mode in which a CPU of the server does not enter a sleep state, and
the controller brings, when the manager determines to run the workload on a certain server, a CPU of the certain server into the power mode in which the CPU does not enter the sleep state.

3. The computer system according to claim 1, wherein
the manager manages the execution of the workload on each of a plurality of the servers,
the controller stores a proportion of standby servers indicating an expected proportion, to the plurality of servers, of servers in a standby state in which power is supplied but their respective CPUs are in the sleep state, and
the controller changes a power mode of a CPU of at least one server of the plurality of servers in accordance with a change in mode of the workload running on the at least one server of the plurality of servers and the proportion of standby servers.

4. The computer system according to claim 3, wherein
when the plurality of servers include a first server that is in the standby state and a second server that is in a power supply interruption state, and the manager determines to run the workload on the first server,
the controller brings a CPU of the first server into the power mode in which the CPU does not enter the sleep state,
the manager runs the workload on the first server, and
the controller brings the second server into the standby state in accordance with the proportion of standby servers.

5. The computer system according to claim 3, wherein when the manager terminates the workload running on a certain server and there is no workload running on the certain server, the controller brings the certain server into either the standby state or the power supply interruption state in accordance with the proportion of standby servers.

6. The computer system according to claim 1, wherein the workload is virtual machine software or a container running on virtualization software.

7. A non-transitory computer-readable storage medium storing a computer program causing a computer to execute:
managing execution of a workload on a server; and
changing a power mode of a CPU of the server in accordance with a change in mode of the workload running on the server.
